(19) United States
(12) Patent Application Publication
(10) Pub. No.: US 2026/0177731 A1
(43) Pub. Date: Jun. 25, 2026

(54) METASURFACE REFLECTOR, PROJECTION DEVICE, AND NEAR-EYE WEARABLE DEVICE

(71) Applicant: TDK CORPORATION, Tokyo (JP)

(72) Inventors: Tetsuya SHIBATA, Tokyo (JP); Tomohito Mizuno, Tokyo (JP); Hideaki Fukuzawa, Tokyo (JP)

(73) Assignee: TDK CORPORATION, Tokyo (JP)

(21) Appl. No.: 19/420,824

(22) Filed: Dec. 16, 2025

(30) Foreign Application Priority Data
Dec. 23, 2024 (JP) 2024-226501

(51) Int. Cl. G02B 5/26; G02B 1/00; G02B 27/01

(52) U.S. Cl. CPC G02B 5/26; G02B 1/002; G02B 27/0172; G02B 2027/0178

(57) ABSTRACT

The metasurface reflector includes a first metal layer and a second metal layer stacked in the z-axis direction, a dielectric layer provided between the first metal layer and the second metal layer in the z-axis direction, and a color filter layer covering the surface of the second metal layer opposite to the dielectric layer. The dielectric layer has a main surface on which the second metal layer is provided. The metasurface reflector is divided into a plurality of unit areas arranged in the x-axis direction along the main surface and in the y-axis direction along the main surface and intersecting with the x-axis direction. The second metal layer includes metal units provided in each of all or some of the plurality of unit areas.

### CROSS-REFERENCE TO RELATED APPLICATION

This application claims a priority, under the Paris Convention, to Japanese Patent Application No. 2024-226501 filed on Dec. 23, 2024, the entirety of which is incorporated herein by reference.

### TECHNICAL FIELD

The present invention relates to a metasurface reflector, a projection device, and a near-eye wearable device.

### BACKGROUND

Currently, glasses-type terminals are being under consideration for AR (Augmented Reality) and VR (Virtual Reality). In particular, in recent years, retinal scanning displays (hereinafter also referred to as “near-eye wearable devices”) that allow users to visually recognize images by forming scanned light on the user's retina have attracted attention.

In retinal scanning displays, three colors of the visible light emitted from red, green, and blue laser diodes are generally multiplexed on one optical axis via a planar lightwave circuit (PLC) or the like. The multiplexed three-color visible light is scanned by a MEMS (Micro Electromechanical Systems) mirror and reflected by a half mirror in front of the user's eye, and enters the user's pupil. This incident light forms an image on the user's retina, thereby making it possible for the user to visually recognize the image (see, for example, Patent Document 1).

A metasurface reflector is used as the half mirror or mirror. A metasurface reflector is a thin film with a nano-level fine structure (nanostructure) that functions as a light reflector.

Patent Document 1 discloses a metasurface reflector as a nanostructure, in which multiple patterns are formed in which multiple rectangular metal bodies of different sizes are arranged in order of size. The reflection angle of the incident laser light is controlled by the size and pattern length of the multiple rectangular metal bodies that make up each pattern. The laser light irradiated to the metasurface reflector as a mirror is scanned, and the reflected laser light is focused on the retina to project an image.

### CITATION LIST

### Patent Document

[Patent document 1] Japanese Patent Application Publication No. 2024-94883

### SUMMARY

However, as recognized by the present inventor, the conventional metasurface reflectors have a problem with chromatic aberration, in which the reflection angle of laser light varies depending on the color (wavelength) of the laser light. The chromatic aberration causes the contours of the image formed on the retina to become blurred, color bleeding occurs, and the clarity of the image viewed decreases.

The present disclosure has been made in consideration of the above problem, and aims to provide a metasurface reflector, a projection device, and a near-eye wearable device that can reduce the chromatic aberration.

### MEANS FOR SOLVING THE PROBLEM

To achieve the above object, the metasurface reflector of the present disclosure is a metasurface reflector comprising a first metal layer and a second metal layer stacked in a first direction, a dielectric layer provided between the first metal layer and the second metal layer in the first direction, and a color filter layer covering the surface of the second metal layer opposite to the dielectric layer, the dielectric layer having a main surface on which the second metal layer is provided, the metasurface reflector being divided into a plurality of unit areas arranged in a second direction along the main surface and a third direction along the main surface and intersecting with the second direction, and the second metal layer includes metal units provided in each of all or some of the plurality of unit areas.

With this configuration, even if RGB multiplexed light, for example R (red light), G (green light), and B (blue light), is incident on the metasurface reflector of the present disclosure, only monochromatic light transmitted through the color filter layer is incident on each metal unit, so that the chromatic aberration, in which the reflection angle of the incident light varies depending on the color of the incident light, can be reduced.

### EFFECTS OF THE INVENTION

According to the present disclosure, it is possible to provide a metasurface reflector, a projection device, and a near-eye wearable device capable of reducing the chromatic aberration.

### BRIED DESCRIPTION OF DRAWINGS

FIG. 1 shows a diagram showing an enlarged view of a metasurface reflector according to an embodiment of the present disclosure attached to the lens of a glasses-type near-eye wearable device.

FIG. 2 shows a perspective view showing a schematic unit area of the metasurface reflector shown in FIG. 1.

FIG. 3 shows a cross-sectional view taken along line III-III in FIG. 2, showing the cross-sectional configuration of a metasurface reflector according to the embodiment of the present disclosure.

FIG. 4 shows a plan view of FIG. 2.

FIG. 5 shows a plan view showing a two-dimensional arrangement of metal units in the metasurface reflector according to the embodiment of the present disclosure.

FIG. 6A is a cross-sectional view taken along line VI-VI in FIG. 5,

FIG. 6B is a diagram showing the state of reflection at the metasurface reflector.

FIG. 7A is a graph showing the relationship between the metal unit length and the reflection angle for each of the RGB incident light.

FIG. 7B is a diagram showing the state of reflection in the metasurface reflector.

FIG. 8 shows a plan view showing a first modified example of the two-dimensional arrangement of metal units in the metasurface reflector according to the embodiment of the present disclosure.

FIG. 9 shows a plan view showing a second modified example of the two-dimensional arrangement of metal units in the metasurface reflector according to the embodiment of the present disclosure.

FIG. 10 shows a plan view showing a third modified example of the two-dimensional arrangement of metal units in the metasurface reflector according to the embodiment of the present disclosure.

FIG. 11 shows a perspective view of a near-eye wearable device.

FIG. 12A is an enlarged perspective view of a projection device.

FIG. 12B is a diagram of the projection device body.

FIG. 13 shows a diagram for explaining the principle of reflection by the metasurface reflector in a glasses-type near-eye wearable device.

FIG. 14 shows a diagram showing the phase change of reflected light at the position in the x-axis direction of the metasurface reflector.

FIG. 15 shows a diagram showing how reflected light converges with respect to incident light by a metal unit arranged so that the length in the x-axis direction changes depending on the position in the x-axis direction.

FIG. 16A is a plan view of a conventional metasurface reflector,

FIG. 16B is a cross-sectional view taken along line B-B in (a).

FIG. 16C is a diagram showing the state of reflection in the metasurface reflector.

FIG. 17A is a graph showing the relationship between the pattern length and reflection angle of the conventional metasurface reflector.

FIG. 17B is a diagram showing the state of reflection in the metasurface reflector.

### DETAILED DESCRIPTION

Hereinafter, an embodiment of the present disclosure will be described in detail with reference to the drawings. Here, for making it easy to understand the following description, the scale of each part in the drawings may differ from the actual scale. In the xyz Cartesian coordinate system set in the figure, the x-axis and y-axis directions are horizontal, and the z-axis direction is vertical. The positive direction of the z-axis is also called the upward direction, and the negative direction of the z-axis is also called the downward direction, but they are not related to the direction of gravity. In the directions of parallel, right angle, orthogonal, horizontal, vertical, up and down, left and right, deviations that do not impair the effect of the embodiment are allowed. In addition, “˜” indicating a numerical range means that the numerical values written before and after it are included as the lower and upper limits.

First, the metasurface reflector 1 according to the embodiment of the present disclosure will be described. Hereinafter, the metasurface reflector 1 of the embodiment will be described as a half mirror attached to the lens 51 of the eyeglass-type near-eye wearable device 100, but the use is not limited to this.

### Configuration

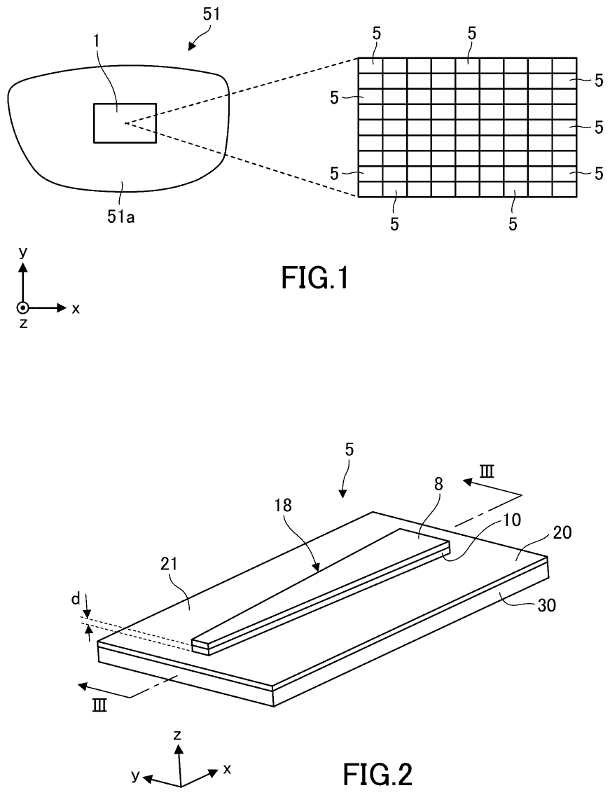

FIG. 1 is an enlarged view of the metasurface reflector 1 according to the embodiment of the present disclosure attached to the lens 51 of the eyeglass-type near-eye wearable device 100. As shown in FIG. 1, the metasurface reflector 1 is provided on the inner surface 51a of the lens 51, and is divided into a plurality of unit areas 5. The unit areas 5 are arranged in a two-dimensional array in the horizontal direction (x-axis direction) and vertical direction (y-axis direction) of the lens 51.

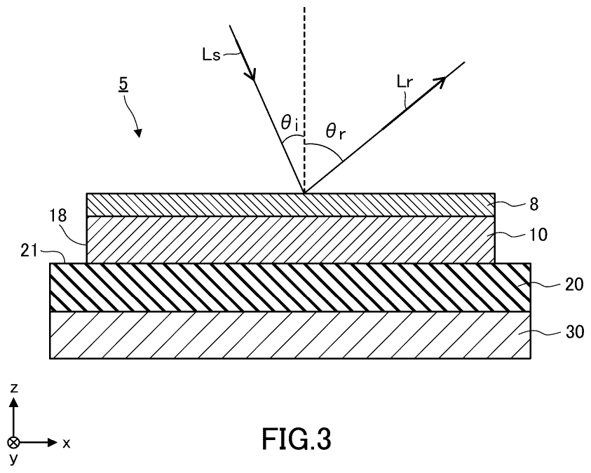

FIG. 2 is a perspective view showing a schematic of the unit region 5. FIG. 3 is a cross-sectional view taken along line III-III in FIG. 2, showing the cross-sectional configuration of the metasurface reflector 1 according to the embodiment of the present disclosure. As shown in FIGS. 2 and 3, the metasurface reflector 1 includes a first metal layer 30 and a second metal layer 10 stacked in the z-axis direction (first direction) in each unit region 5, a dielectric layer 20 provided between the first metal layer 30 and the second metal layer 10 in the z-axis direction, and a color filter layer 8 covering the surface of the second metal layer 10 opposite to the dielectric layer 20. In other words, the metasurface reflector 1 is a laminate including the first metal layer 30, the dielectric layer 20, the second metal layer 10, and the color filter layer 8 in this order in the positive direction of the z-axis.

The dielectric layer 20 has a main surface 21 on which the second metal layer 10 is provided. The metasurface reflector 1 is divided into a plurality of unit areas 5 arranged two-dimensionally in the x-axis direction (second direction) along the main surface 21 and in the y-axis direction (third direction) along the main surface 21 and intersecting with the x-axis direction. The second metal layer 10 includes metal units 18, which are nanostructures provided in each of all or some of the plurality of unit areas 5. The metasurface reflector 1 may be, for example, a thin plate or film, and may be rectangular, square, polygonal, circular, etc. in plan view from the z-axis direction.

The light incident on the metasurface reflector 1 from the color filter layer 8 side is reflected at a predetermined angle depending on the wavelength, the angle of incidence, the shape of the metal units 18, etc. FIG. 3 shows how the incident light (laser light) Ls is incident on the metasurface reflector 1 at an incident angle θi, and the reflected light Lr is reflected at a reflection angle θr. As shown in FIG. 3, the incident angle θi is the angle between the normal of the surface onto which the incident light Ls is irradiated and the incident direction of the incident light Ls. The reflection angle θr is the angle between the normal of the surface onto which the incident light Ls is irradiated and the emission direction of the reflected light Lr. In a plane including the incident light Ls and the reflected light Lr, when the reflected light Lr is emitted on the opposite side of the incident light Ls with the normal as a boundary, the reflection angle θr is expressed as a positive value, and when the reflected light Lr is emitted on the same side as the incident light Ls with the normal as a boundary, the reflection angle θr is expressed as a negative value.

The “light” described in this specification is assumed to be visible light, but is not limited to this visible light, and may be infrared light with a longer wavelength than the visible light or ultraviolet light with a shorter wavelength than the visible light. The wavelength of the visible light is, for example, 380 nm or more and less than 800 nm. The wavelength of the infrared light is, for example, 800 nm or more and 1 mm or less. The wavelength of the ultraviolet light is, for example, 200 nm or more and less than 380 nm.

Each component will be described hereinafter.

### <First Metal Layer>

The first metal layer 30 is a layer which is to be a base layer. The first metal layer 30 is made of a metal or alloy containing at least one element selected from the group consisting of gold (Au), copper (Cu), silver (Ag), aluminum (Al), iridium (Ir), ruthenium (Ru), rhodium (Rh), titanium (Ti), tantalum (Ta), tungsten (W), cobalt (Co), iron (Fe), and nickel (Ni). The length (thickness) of the first metal layer 30 in the z-axis direction may be such that the first metal layer 30 can pass a resonant current when light is incident and can reflect light, and is, for example, 50 nm or more and 1000 nm or less.

### <Dielectric Layer>

The dielectric layer 20 is a layer that functions as a spacer. The dielectric layer 20 is provided on the first metal layer 30. The dielectric layer 20 is made of, for example, a material that is transparent in the visible light region. The dielectric layer 20 has a dielectric constant that does not inhibit the electromagnetic action of the second metal layer 10 and the first metal layer 30. The dielectric layer 20 may be made of a material with a high dielectric constant in order to achieve high reflection characteristics. The dielectric layer 20 is made of at least one compound selected from the group consisting of silicon oxide (e.g., SiO2), titanium oxide (e.g., TiO2), magnesium oxide (e.g., MgO), and aluminum oxide (e.g., Al2O3). The length (thickness) of the dielectric layer 20 in the z-axis direction is, for example, 10 nm or more and 100 nm or less.

### <Second Metal Layer>

The second metal layer 10 is made of a metal and constitutes a nanostructure, which is a nanoscale structure. The second metal layer 10 is a layer that excites electromagnetic resonance together with the first metal layer 30. In detail, the incident electric field of light, which is an electromagnetic wave incident on the second metal layer 10, resonates through the dielectric layer 20, generating an electric field in the opposite direction in the first metal layer 30. A magnetic field in the opposite direction to the incident magnetic field is generated in the dielectric layer 20. This reverses the traveling direction of the light, which is an electromagnetic wave.

The second metal layer 10 is provided on the main surface 21 of the dielectric layer 20 opposite to the first metal layer 30. The second metal layer 10 is made of a metal or alloy containing at least one element selected from the group consisting of silver (Ag), aluminum (Al), and copper (Cu), for example. The second metal layer 10 may be made of the same material as the first metal layer 30, for example.

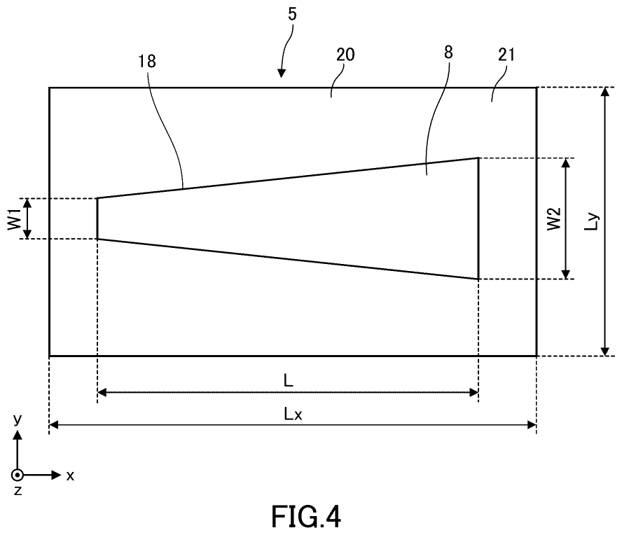

As shown in FIGS. 2 and 4, the metal unit 18 is a metal body having a trapezoidal shape in a planar view seen from the z-axis direction.

The trapezoidal metal unit 18 has a length L in a direction perpendicular to both parallel short and long sides of the trapezoid, i.e., in the x-axis direction (hereinafter also referred to as the “longitudinal direction”), of, for example, 500 nm or more and 2500 nm or less. The thickness d of the metal unit 18 in the z-axis direction is, for example, 10 nm or more and 100 nm or less. Of the parallel short and long sides of the trapezoidal shape of the metal unit 18, the length W1 of the short side is, for example, 10 nm or more and 200 nm or less, and the length W2 of the long side is greater than the length W1 of the short side, for example, 100 nm or more and 500 nm or less. Making the metal unit 18 such a size can increase the reflection efficiency for the visible light.

The second metal layer 10 may include a plurality of metal units 18 arranged two-dimensionally in the x-axis direction and the y-axis direction (see FIGS. 1, 2, and 5). The interval between two adjacent metal units 18 in the x-axis direction is set so that the wavefront of the reflected light is continuous. This interval may be set to a size that does not cause the two metal units 18 to come into contact with each other, for example, to a value equal to or less than half the wavelength of the incident light (laser light) Ls. The interval is, for example, about 20 nm. The plurality of metal units 18 are formed, for example, by photolithography.

The length Lx of each unit area 5 shown in FIG. 4 is determined from the wavelength λ of the light to be reflected and the angle of incidence θi and the angle of reflection θr corresponding to the position where the unit area 5 is provided. The length L of the metal unit 18 in the x-axis direction is the same as or slightly shorter than the length Lx of the unit area 5 in the x-axis direction. Therefore, the length L of the metal unit 18 in the x-axis direction is determined from the wavelength λ of the light to be reflected and the angle of incidence θi and the angle of reflection θr corresponding to the position of the unit areas 5 in which the metal unit 18 is provided.

In this embodiment, the lengths Lx of the unit areas 5 included in the same row in the x-axis direction in the two-dimensional array are different from each other, and the lengths L of the metal units 18 included in the same row in the x-axis direction are also different from each other.

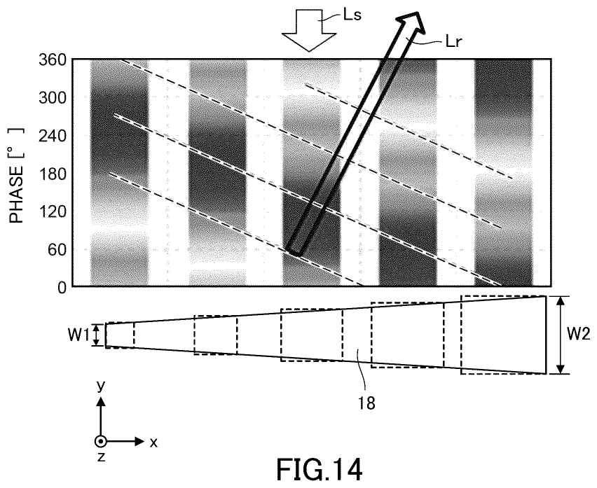

The length Ly of each unit areas 5 is a predetermined fixed value. The length Ly is slightly larger than the width W2. The length Ly may be the length obtained by adding the resolution (e.g., 100 nm) of the exposure device used to form the metal unit 18 to the width W2, and is set to, for example, 600 nm. The widths W1 and W2 of each metal unit 18 are predetermined fixed values. As described above, the width W1 is set to be close to the resolution (e.g., 100 nm) of the exposure device used to form the metal unit 18. The width W2 is set to a length (e.g., 350 nm) that provides a phase difference of substantially 360° (2π radians) from the phase of the reflected light Lr at the width W1 (see FIG. 14).

### <Color Filter Layer>

The color filter layer 8 is made of a material that transmits light of a specific wavelength or wavelength range. The color filter layer 8 is made of a metal or alloy that contains at least one element selected from the group consisting of iron (Fe), chromium (Cr), cobalt (Co), and titanium (Ti). The color filter layer 8 is, for example, a red filter layer 8R that transmits only red light, a green filter layer 8G that transmits only green light, or a blue filter layer 8B that transmits only blue light. For example, the red filter layer 8R may transmit red light (e.g., a wavelength range of 590 nm or more and less than 800 nm or a part thereof), the green filter layer 8G may transmit green light (e.g., a wavelength range of 490 nm or more and less than 590 nm or a part thereof), and the blue filter layer 8B may transmit blue light (e.g., a wavelength range of 380 nm or more and less than 490 nm or a part thereof).

The red filter layer 8R is made of, for example, cadmium selenide (CdSe) or iron oxide (Fe₂O₃). The layer thickness of the red filter layer 8R is, for example, 50 nm to 250 nm. The green filter layer 8G is made of, for example, chromium oxide (Cr₂O₃) or nickel oxide (NiO). The layer thickness of the green filter layer 8G is, for example, 100 nm to 300 nm. The blue filter layer 8B is made of, for example, cobalt oxide (CoO) or copper oxide (CuO). The thickness of the blue filter layer 8B is, for example, 150 nm to 350 nm.

### Arrangement of Metal Units

First, for comparison, a conventional metasurface reflector 1000 will be described.

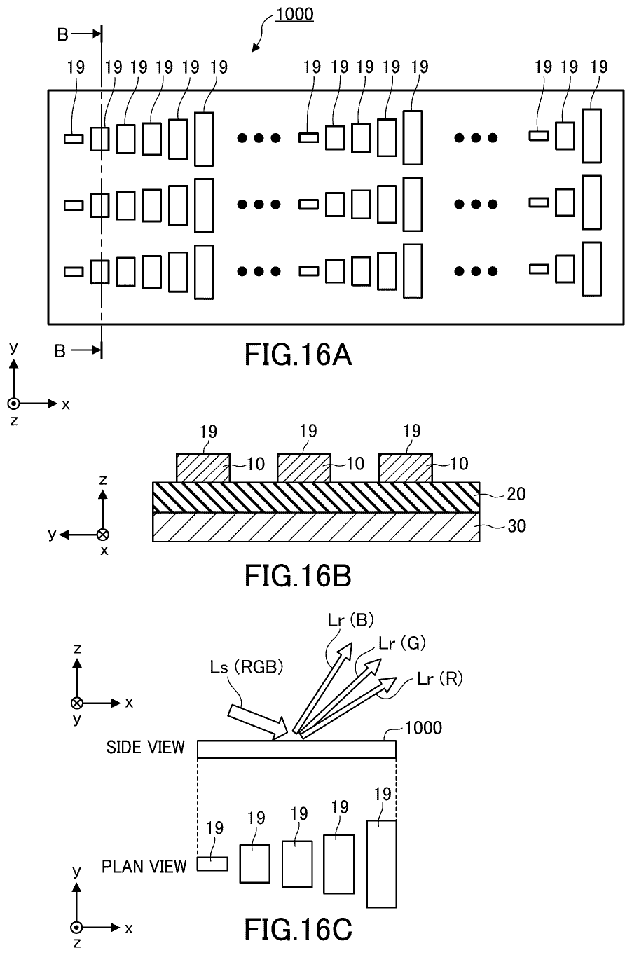

FIG. 16A is a plan view of the conventional metasurface reflector 1000, FIG. 16 is a cross-sectional view taken along line B-B in FIG. 16A, and FIG. 16C is a diagram showing the reflection state of the conventional metasurface reflector 1000. As shown in FIGS. 16A and 16B, the conventional metasurface reflector 1000 has a first metal layer 30, a dielectric layer 20, and a second metal layer 10 stacked in this order in the z-axis direction. The second metal layer 10 is made of a plurality of rectangular metal bodies 19 as nanostructures. In one unit area, multiple rectangular metal bodies 19 whose size gradually increases in the x-axis direction are arranged at intervals from each other to form one pattern (corresponding to a metal unit). The pattern length gradually decreases in the x-axis direction.

As shown in FIG. 16C, in the conventional metasurface reflector 1000, when RGB multiplexed light Ls (RGB) obtained by multiplexing red laser light, green laser light, and blue laser light is incident on the pattern of the metal body 19 at a predetermined incident angle, the red reflected light Lr (R), green reflected light Lr (G), and blue reflected light Lr (B) are reflected separately at different reflection angles. That is, in the conventional metasurface reflector 1000, the chromatic aberration occurs when the RGB multiplexed light Ls (RGB) is incident.

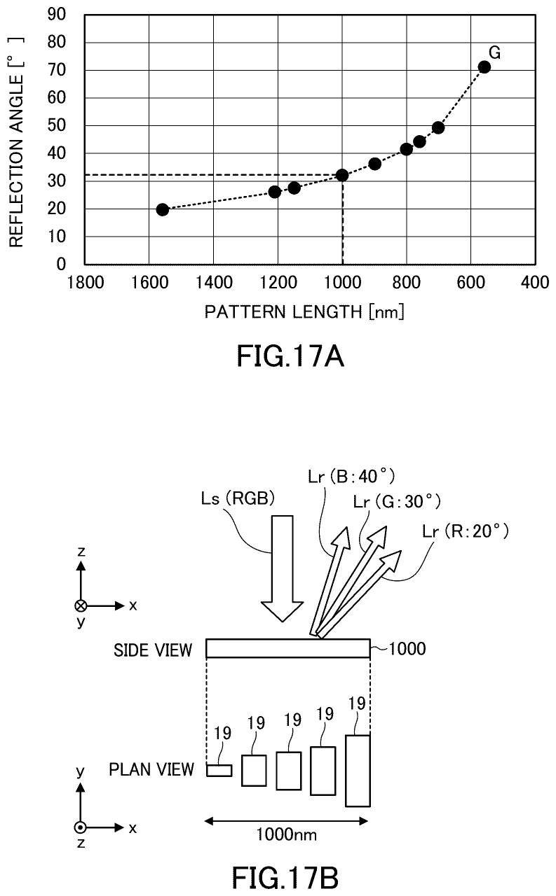

FIG. 17A is a graph showing the relationship between the pattern length and the reflection angle of a conventional metasurface reflector 1000, and FIG. 17B is a diagram showing the state of reflection in a conventional metasurface reflector 1000 with a pattern length of 1000 nm. As shown in FIG. 17A and FIG. 17B, for example, when RGB multiplexed light Ls (RGB) is perpendicularly incident on a pattern with a length in the x-axis direction (longitudinal direction) of 1000 nm on the conventional metasurface reflector 1000, the green reflected light Lr (G) is reflected at a reflection angle of 30°, while the blue reflected light Lr (B) is reflected at a reflection angle of 40°, and the red reflected light Lr (R) is reflected at a reflection angle of 20°. In other words, the chromatic aberration occurs.

Next, the arrangement of the metal units 18 in the metasurface reflector 1 according to the embodiment of the present disclosure will be described.

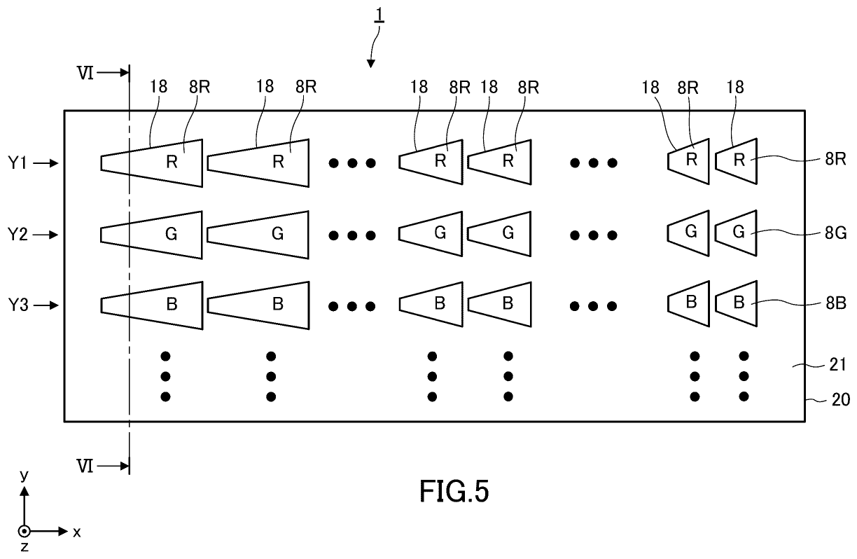

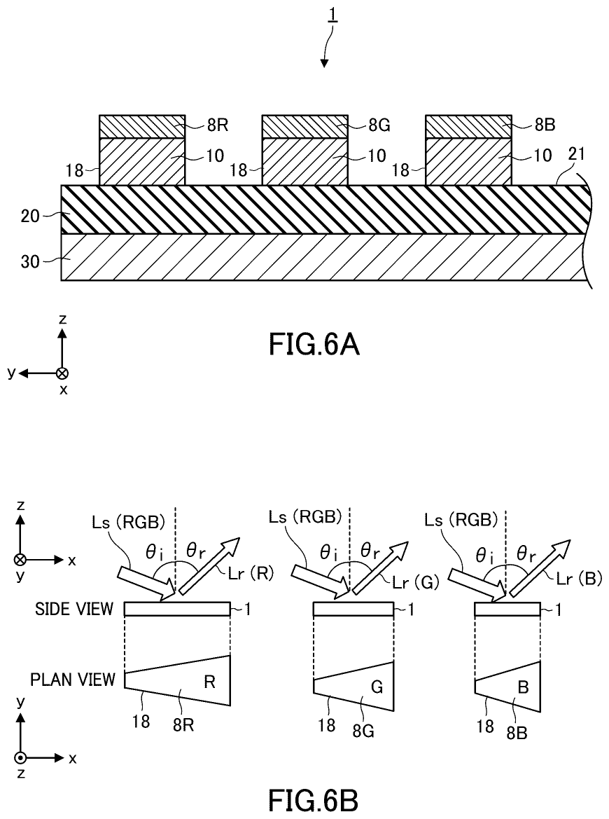

FIG. 5 is a plan view showing a two-dimensional arrangement of metal units 18 in a metasurface reflector 1 according to the embodiment of the present disclosure. FIG. 6A is a cross-sectional view taken along line VI-VI in FIG. 5, and FIG. 6B is a diagram showing the state of reflection in the metasurface reflector 1. As shown in FIG. 5 and FIG. 6(a), the metasurface reflector 1 has a first metal layer 30, a dielectric layer 20, a second metal layer 10, and a color filter layer 8 stacked in this order in the positive direction of the z-axis. Specifically, the color filter layer 8 is, for example, a red filter layer 8R, a green filter layer 8G, or a blue filter layer 8B.

In FIG. 5, the transmitted color of the color filter layer 8 is indicated by the letters “R”, “G”, or “B” on the trapezoidal metal units 18. That is, “R” indicates that a red filter layer 8R is provided on the metal unit 18, “G” indicates that a green filter layer 8G is provided on the metal unit 18, and “B” indicates that a blue filter layer 8B is provided on the metal unit 18.

As shown in FIG. 5, the metal units 18 arranged in the Y1 row in the x-axis direction are provided with a red filter layer 8R, the metal units 18 arranged in the Y2 row are provided with a green filter layer 8G, and the metal units 18 arranged in the Y3 row are provided with a blue filter layer 8B. Similarly, for the rows after the Y3 row, the transmission color of the color filter layer 8 is set for each row, so that the transmission color of the color filter layer 8 changes when the row changes.

FIG. 6B is a diagram showing the state of reflection at the three metal units 18 shown in FIG. 6A. As shown in FIG. 6B, when the RGB multiplexed light Ls (RGB) is incident on the metal unit 18 provided with the red filter layer 8R at a predetermined incident angle θi, the red reflected light Lr (R) is reflected at a reflection angle θr. When the RGB multiplexed light Ls (RGB) is incident at a predetermined incident angle θi on the metal unit 18 provided with the green filter layer 8G, the green reflected light Lr (G) is reflected at a reflection angle θr. When the RGB multiplexed light Ls (RGB) is incident at a predetermined incident angle θi on the metal unit 18 provided with the blue filter layer 8B, the blue reflected light Lr (B) is reflected at a reflection angle θr.

In this way, when the RGB multiplexed light Ls (RGB) is incident at a predetermined incident angle θi on these three types of metal units 18 that are located at the same position in the x-axis direction, the red reflected light Lr (R), the green reflected light Lr (G), and the blue reflected light Lr (B) are each reflected at the same reflection angle θr. For this reason, the metal unit lengths of the metal units 18 in the two-dimensional array are changed for each transmitted color of the color filter layer 8 depending on the position in the x-axis direction.

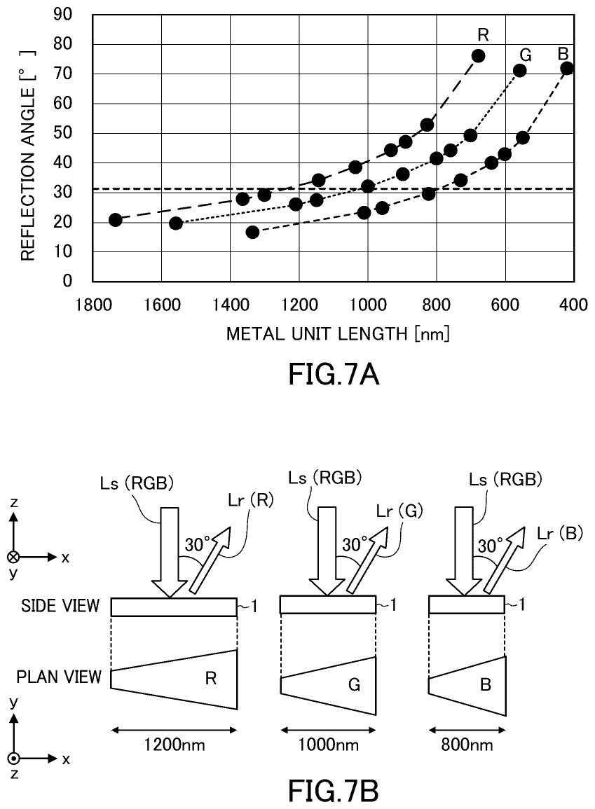

FIG. 7A is a graph showing the relationship between metal unit length and reflection angle for each color (R, G, B) of incident light, and FIG. 7B is a diagram showing the state of reflection in the metasurface reflector 1. As shown in FIG. 7A, the relationship between metal unit length and reflection angle differs for each color (R, G, B) of incident light.

In the metasurface reflector 1 used in the near eyewear wearable device 100, metal units 18 that are located at the same or close positions on the x-axis must have the same or nearly the same reflection angles for the red reflected light Lr(R), green reflected light Lr(G), and blue reflected light Lr(B). For this reason, the longitudinal lengths (metal unit lengths) of the metal units 18 are made different to make the reflection angles uniform.

For example, as shown in FIG. 7B, when the metal unit length of the metal unit 18 provided with the red filter layer 8R is set to 1200 nm, the reflection angle of the red reflected light Lr(R) is 30°. When the metal unit length of the metal unit 18 provided with the green filter layer 8G is set to 1000 nm, the reflection angle of the green reflected light Lr(G) is 30°. When the metal unit length of the metal unit 18 provided with the blue filter layer 8B is set to 800 nm, the reflection angle of the blue reflected light Lr(B) is 30°. By arranging these metal units 18 at the same or close positions on the x-axis, the red reflected light Lr(R), the green reflected light Lr(G), and the blue reflected light Lr(B) can be reflected at the same reflection angle. This makes it possible to realize a metasurface reflector 1 that can be used in a near-eye wearable device 100 without generating the chromatic aberration.

As described above, the metasurface reflector 1 according to this embodiment reduces the chromatic aberration by using a color filter layer 8. The RGB color filter layers 8 are arranged on the trapezoidal metal units 18, which are the basic element pattern. As a result, even if the RGB multiplexed light Ls (RGB) is irradiated onto the metal units 18, one metal unit 18 reflects only one wavelength, i.e., one color of laser light, that has passed through the color filter layer 8, so that no chromatic aberration occurs. By adjusting the size (e.g., metal unit length) of the metal units 18 on which the color filter layers 8 are provided, it is possible to make all RGB have the same reflection angle at the same position in the x-axis direction and in the vicinity thereof.

### First Modification of the Array of Metal Units

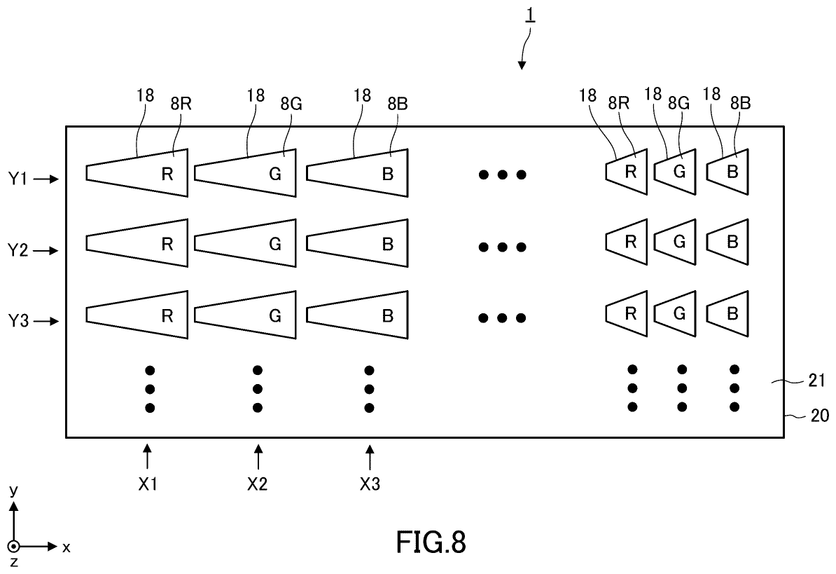

FIG. 8 is a plan view showing a first modification of the two-dimensional array of the metal units 18 in the metasurface reflector 1 according to the embodiment of the present disclosure.

As shown in FIG. 8, the metal units 18 arranged in an X1 row in the y-axis direction are provided with a red filter layer 8R, the metal units 18 arranged in an X2 row in the y-axis direction are provided with a green filter layer 8G, and the metal units 18 arranged in an X3 row in the y-axis direction are provided with a blue filter layer 8B. Similarly, for the rows after the X3 row, the transmission color of the color filter layer 8 is set for each row, so that the transmission color of the color filter layer 8 changes when the row changes.

The metal units 18 arranged in a Y1 row in the x-axis direction are provided with a red filter layer 8R, a green filter layer 8G, and a blue filter layer 8B that are repeated in order. The same is true for the Y2 row, the Y3 row, . . . , after the Y1 row.

In the first modification, when RGB multiplexed light is incident at a predetermined angle on metal units 18 that are at the same or nearly the same position in the x-axis direction, the red reflected light, green reflected light, and blue reflected light are reflected at the same reflection angle. For this reason, the metal units 18 in the two-dimensional array have metal unit lengths that vary for each transmitted color of the color filter layer 8 depending on the position in the x-axis direction.

With this configuration, for example, in the near-eye wearable device 100, it is possible to reduce the chromatic aberration and project a full-color image clearly onto the retina.

### Second Modification of the Metal Unit Array

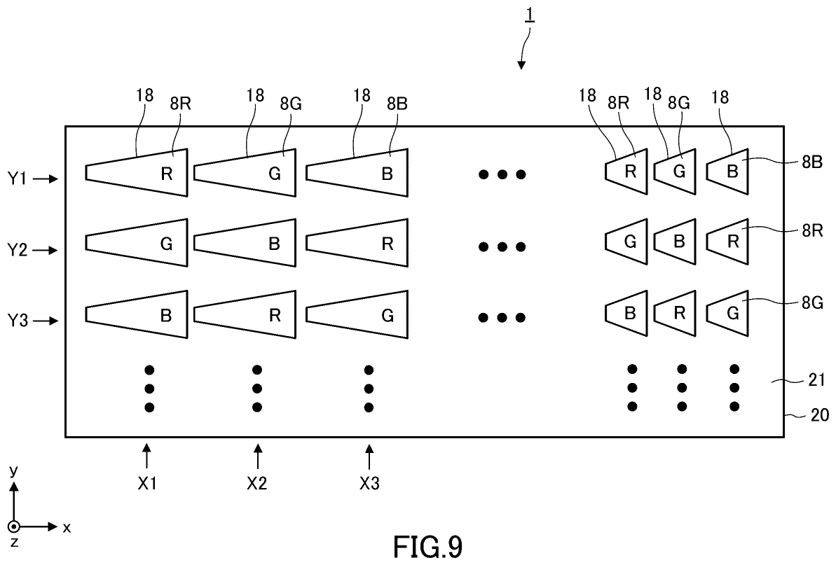

FIG. 9 is a plan view showing a second modification of the two-dimensional array of metal units 18 in the metasurface reflector 1 according to the embodiment of the present disclosure.

As shown in FIG. 9, the metal units 18 arranged in a Y1 row in the x-axis direction are provided with a red filter layer 8R, a green filter layer 8G, and a blue filter layer 8B, which are repeated in sequence. The metal units 18 arranged in a Y2 row in the x-axis direction are provided with a green filter layer 8G, a blue filter layer 8B, and a red filter layer 8R, which are repeated in sequence. The metal units 18 arranged in a Y3 row in the x-axis direction are provided with a blue filter layer 8B, a red filter layer 8R, and a green filter layer 8G, which are repeated in sequence. The same applies to the rows after the Y3 row.

The metal units 18 arranged in an X1 row in the y-axis direction are provided with a red filter layer 8R, a green filter layer 8G, and a blue filter layer 8B, which are repeated in sequence. The metal units 18 arranged in an X2 row in the y-axis direction are provided with a green filter layer 8G, a blue filter layer 8B, and a red filter layer 8R, which are repeated in sequence. The metal units 18 arranged in an X3 rows in the y-axis direction are provided with a blue filter layer 8B, a red filter layer 8R, and a green filter layer 8G arranged in a repeated in sequence. The same applies to the rows after the X3 row.

In the second modified example, when RGB combined light is incident at a predetermined angle on metal units 18 that are at the same or nearly the same position in the x-axis direction, the red reflected light, the green reflected light, and the blue reflected light are reflected at the same reflection angle. For this reason, the metal units 18 in the two-dimensional array have metal unit lengths that are changed for each transmitted color of the color filter layer 8 depending on the position in the x-axis direction.

With this configuration, for example, in the near-eye wearable device 100, the chromatic aberration can be reduced and a full-color image can be clearly projected onto the retina.

### Third Modified Example of the Arrangement of Metal Units

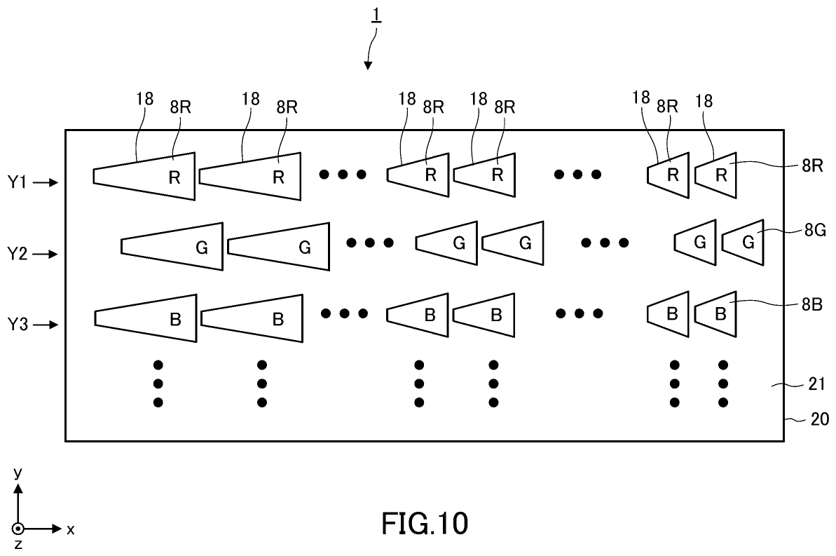

FIG. 10 is a plan view showing a third modified example of the two-dimensional arrangement of metal units 18 in the metasurface reflector 1 according to the embodiment of the present disclosure.

As shown in FIG. 10, the metal units 18 arranged in the Y1 row in the x-axis direction are provided with a red filter layer 8R, the metal units 18 arranged in the Y2 row are provided with a green filter layer 8G, and the metal units 18 arranged in the Y3 row are provided with a blue filter layer 8B. In the third modified example, the metal units 18 in the Y2 row are shifted in the x-axis direction with respect to the metal units 18 in the Y1 and Y3 rows. Similarly, for the rows after the Y3 row, the transmission color of the color filter layer 8 is set for each row, so that the transmission color of the color filter layer 8 changes when the row changes.

In the third modified example, when RGB multiplexed light is incident at a predetermined angle on metal units 18 that are at the same or nearly the same position in the x-axis direction, the red reflected light, green reflected light, and blue reflected light are reflected at the same reflection angle. For this reason, the metal units 18 in the two-dimensional array have metal unit lengths that vary for each transmitted color of the color filter layer 8 depending on the position in the x-axis direction.

With this configuration, for example, in the near-eye wearable device 100, the chromatic aberration can be reduced and a full-color image can be clearly projected onto the retina.

### Manufacturing Process

The metasurface reflector 1 is obtained by sequentially forming the first metal layer 30, the dielectric layer 20, the second metal layer 10, and the color filter layer 8 on a substrate using techniques such as sputtering and photolithography. The substrate may be a sapphire substrate, a flexible sheet, or a quartz substrate.

Specifically, the first metal layer 30 is formed on the substrate by vacuum film formation using techniques such as DC (Direct Current) sputtering. The first metal layer 30 is formed using a metal material selected from the group consisting of gold (Au), copper (Cu), silver (Ag), iridium (Ir), ruthenium (Ru), rhodium (Rh), titanium (Ti), tantalum (Ta), tungsten (W), cobalt (Co), iron (Fe), and nickel (Ni), or a metal alloy containing at least one element selected from the group. The first metal layer 30 is formed to a film thickness of, for example, 50 nm ˜1000 nm.

Then, the dielectric layer 20 is formed on the first metal layer 30. Specifically, the dielectric layer 20 is formed by vacuum film formation using techniques such as RF (Radio Frequency) sputtering. The dielectric layer 20 is formed from dielectric materials such as silicon oxide (for example, SiO₂), titanium oxide (for example, TiO₂), magnesium oxide (for example, MgO), and aluminum oxide (for example, Al₂O₃) that can be formed by a semiconductor process. The dielectric layer 20 is formed to a film thickness of, for example, 10 nm to 100 nm.

Then, a metal layer (hereinafter referred to as the “outermost metal layer”) that will become the second metal layer 10 is formed on the dielectric layer 20. The outermost metal layer is made of a metal or alloy containing at least one element selected from the group consisting of silver (Ag), aluminum (Al), and copper (Cu), and is formed by techniques such as sputtering, similar to the first metal layer 30. The outermost metal layer is formed to a film thickness of, for example, 10 nm ˜100 nm.

Then, the second metal layer 10 (multiple nanostructures) is formed by a photolithography process and an etching process. Specifically, a liquid resist is applied to the outermost metal layer using a spin coater or the like, and the applied liquid resist is dried to form a resist film (photoresist). Then, a pattern corresponding to the metal units 18 of the nanostructure is transferred to the resist film using an exposure device such as a KrF exposure device or an electron beam lithography device. Then, the pattern transferred to the resist film is developed using a developing device. Then, the portion of the outermost metal layer that is not covered by the pattern is removed by ion milling, and then the resist film is removed. This results in forming the second metal layer 10. The width W1 of each metal unit 18 is, for example, 10 nm ˜200 nm, the width W2 is, for example, 100 nm ˜500 nm, and the length L is, for example, 500 nm ˜2500 nm (see FIG. 4).

Then, a color filter layer 8 is formed by techniques such as sputtering so as to cover the second metal layer 10. At that time, the portion where the color filter layer 8 is not to be formed is kept masked. In this way as above, the metasurface reflector 1 can be formed.

The metasurface reflector 1 may be formed directly on a lens of glasses or a half mirror, instead of on a substrate, depending on the application. The formation method is the same as the method for forming the metasurface reflector 1 on a substrate.

### Projection Device and Near-Eye Wearable Device

The metasurface reflector 1 according to this embodiment can be applied to, for example, a projection device 60 or a near-eye wearable device 100 equipped with the projection device 60.

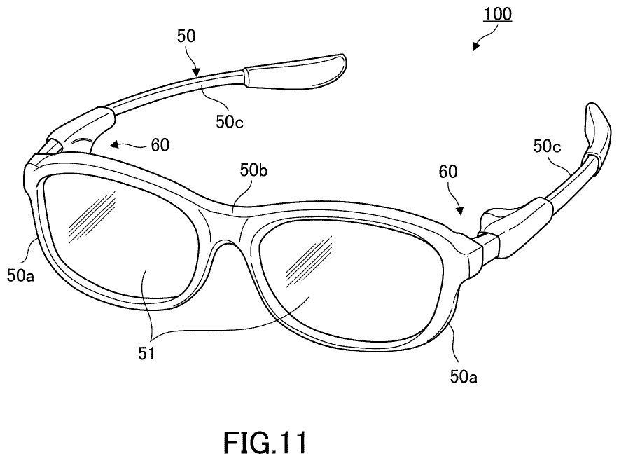

FIG. 11 is a perspective view of the near-eye wearable device 100. The near-eye wearable device 100 is a device that overlays an image on the field of view of the real world. The near-eye wearable device 100 is, for example, a head-mounted device. In this example, the device is a glasses-type device, but this device can take any form selected from among a goggles-type, a hat-type, a helmet-type, and the like. Examples of the near-eye wearable device 100 include smart glasses such as AR glasses and MR (Mixed Reality) glasses. The near-eye wearable device 100 in FIG. 11 includes a frame 50, a lens 51 attached to the rim 50a, and a projection device 60 attached to the temple 50c. The lens 51 is provided with a metasurface reflector 1.

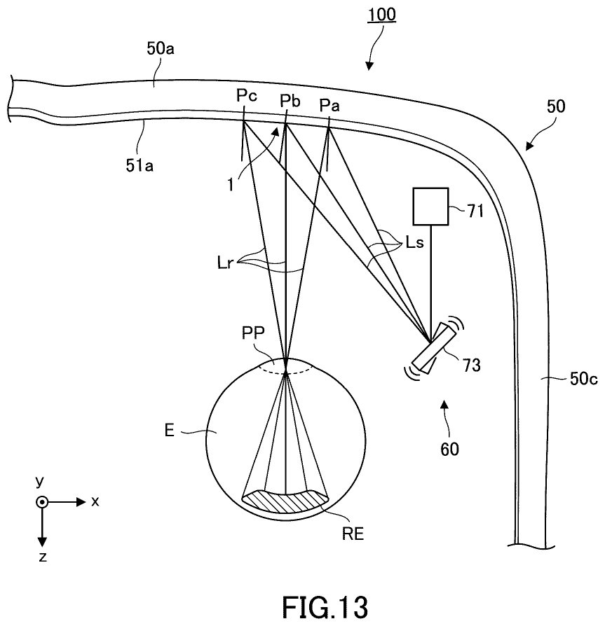

The frame 50 includes a pair of rims 50a, a bridge 50b, and a pair of temples 50c. The rim 50a is a part that holds the lens 51. The bridge 50b is a portion that connects the pair of rims 50a. The temples 50c are portions that extend from the rims 50a and are hung on the user's ears. The frame 50 may be a rimless frame. The lens 51 has an inner surface 51a (see FIG. 1) that faces the eyeball E (see FIG. 13) of the user wearing the near-eye wearable device 100.

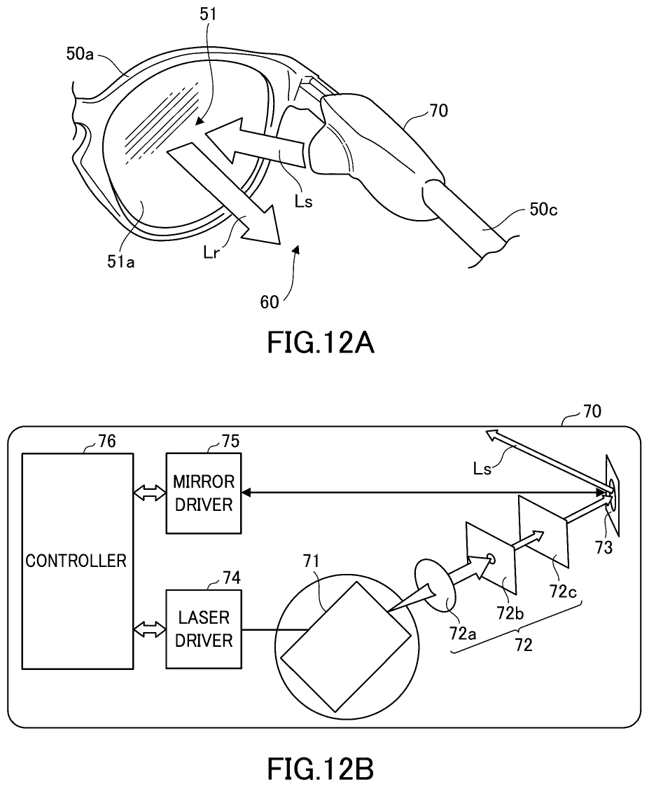

FIG. 12A is an enlarged perspective view of the projection device 60, and FIG. 12B is a configuration diagram of the optical engine 70. The projection device 60 is a device that directly projects (draws) an image onto the retina RE of the user wearing the near-eye wearable device 100. The projection device 60 is mounted on the near-eye wearable device 100. The projection device 60 includes an optical engine 70 attached to the frame 50 and a metasurface reflector 1 attached to the lens 51.

The optical engine 70 is a device that generates laser light Ls with a color and intensity corresponding to the pixels of the image projected onto the retina RE, and emits the laser light Ls to the metasurface reflector 1. The optical engine 70 is mounted on each temple 50c. The optical engine 70 includes a light source unit (light source) 71, optical components 72, a movable mirror 73, a laser driver 74, a mirror driver 75, and a controller 76.

The light source unit 71 emits laser light. For example, a full-color laser module is used as the light source unit 71. The light source unit 71 includes a red laser diode, a green laser diode, a blue laser diode, and a multiplexing section that multiplexes the laser light emitted from each laser diode into one laser light. The light source unit 71 emits the multiplexed laser light. The multiplexed laser light includes a component having a red wavelength (red component), a component having a green wavelength (green component), and a component having a blue wavelength (blue component). The light source unit 71 emits laser light of a color and intensity corresponding to the pixels of the image to be projected onto the retina RE.

The optical component 72 is a component that optically processes the laser light emitted from the light source unit 71. In this embodiment, the optical component 72 includes a collimator lens 72a, a slit 72b, and a neutral density filter 72c. The collimator lens 72a, the slit 72b, and the neutral density filter 72c are arranged in that order along the optical path of the laser light. The optical component 72 may have other configurations.

The movable mirror 73 is a member for performing scanning with the laser light Ls. The movable mirror 73 is provided in the emission direction of the laser light processed by the optical component 72. The movable mirror 73 is configured to be oscillating, for example, around an axis extending in the horizontal direction (x-axis direction) of the lens 51 and around an axis extending in the vertical direction (y-axis direction) of the lens 51, and reflects the laser light by changing the angle in the x-axis direction and the y-axis direction. For example, a MEMS mirror is used as the movable mirror 73.

The laser driver 74 is a drive circuit that drives the light source unit 71. The laser driver 74 drives the light source unit 71 based on, for example, the optical power of the laser light and the temperature of the light source unit 71. The mirror driver 75 is a drive circuit that drives the movable mirror 73. The mirror driver 75 oscillates the movable mirror 73 within a predetermined angle range and at a predetermined timing. The controller 76 is a device that controls the laser driver 74 and the mirror driver 75.

In the optical engine 70, laser light of a color and intensity corresponding to the pixels of the image to be projected onto the retina RE is emitted from the light source unit 71, passes through the optical component 72, and is reflected by the movable mirror 73. The movable mirror 73 is a component for performing scanning with the laser light (incident light). The laser light reflected by the movable mirror 73 is emitted to the metasurface reflector 1 as laser light Ls.

The metasurface reflector 1 is a component that reflects the laser light Ls that has passed through the movable mirror 73, and irradiates the reflected light Lr onto the retina RE of the user wearing the near-eye wearable device 100, thereby projecting an image onto the retina RE. The user visually recognizes the image projected onto the retina RE. The image is not displayed on the metasurface reflector 1.

In this embodiment, the near-eye wearable device 100 includes two projection devices 60 in order to project images onto both the left and right retinas, but the near-eye wearable device 100 may include only one of the projection devices 60.

### Reflection by the Metasurface Reflector in the Near-Eye Wearable Device

Next, the principle of light reflection by the metasurface reflector 1 in the near-eye wearable device 100 according to the embodiment of the present disclosure will be described hereinafter.

As shown in FIG. 1, the metasurface reflector 1 has a plurality of unit areas 5. Each unit area 5 has a metal unit 18 configured to reflect incident light Ls (laser light) at a reflection angle θr corresponding to the position where the unit area 5 is located when the incident light Ls is incident at an incident angle θi corresponding to the position where the unit area 5 is located (FIG. 2). For example, the reflection angle θr of each unit area 5 is set so that the incident light Ls (i.e., the reflected light Lr) reflected by each unit area 5 passes through the center of the pupil PP of the user's eyeball E. Therefore, the incident angle θi and the reflection angle θr are determined by the position where the unit area 5 is located. The unit area 5 is configured so that the incident angle θi and the reflection angle θr corresponding to the position where the unit area 5 is located can be obtained.

FIG. 13 is a diagram for explaining the principle of reflection by the metasurface reflector 1 in the eyeglass-type near-eye wearable device 100. As shown in FIG. 13, for example, when the user's pupil PP faces forward, the unit area 5 located from position Pa to position Pc in the x-axis direction is used. The incident light Ls reflected by the unit area 5 located at position Pa corresponds to the rightmost pixel of the image projected onto the retina RE. Position Pb is located halfway between positions Pa and Pc, and the incident light Ls reflected by the unit area 5 located at position Pb corresponds to the central pixel of the image. The incident light Ls reflected by the unit area 5 located at position Pc corresponds to the leftmost pixel of the image.

Specifically, in the unit area 5 located at position Pa, for example, the incident light Ls is incident at an incident angle θi of 30°, and the incident light Ls is reflected at a reflection angle θr of 5° and emitted as reflected light Lr. In the unit area 5 located at position Pb, for example, the incident light Ls is incident at an incident angle θi of 40°, and the incident light Ls is reflected at a reflection angle θr of −5° and emitted as reflected light Lr. In the unit area 5 provided at the position Pc, for example, the incident light Ls is incident at an incident angle θi of 50°, and the incident light Ls is reflected at a reflection angle θr of −10° and emitted as reflected light Lr.

FIG. 14 is a diagram showing the phase change amount of the reflected light Lr at a position in the x-axis direction of the metasurface reflector 1. As shown in FIG. 14, the width of the metal unit 18 increases from width W1 to width W2 along the x-axis direction. The phase change amount at each position in the x-axis direction of the metal unit 18 is substantially the same as the phase change amount caused by a square metal body (square indicated by a dashed line) having sides the same length as the width at that position in a plan view. The larger the area of the square metal body in a plan view, the larger the phase change amount (phase delay amount) at that position. In this way, the incident light Ls is reflected with a different phase change amount depending on the position in the x-axis direction, so that a wavefront can be formed by interference between the reflected lights. That is, a plane wave is generated that travels in a direction determined by the relationship between the position in the x-axis direction and the amount of phase change. The reflection angle varies depending on the length of the metal unit 18 in the x-axis direction (pattern length), and the like.

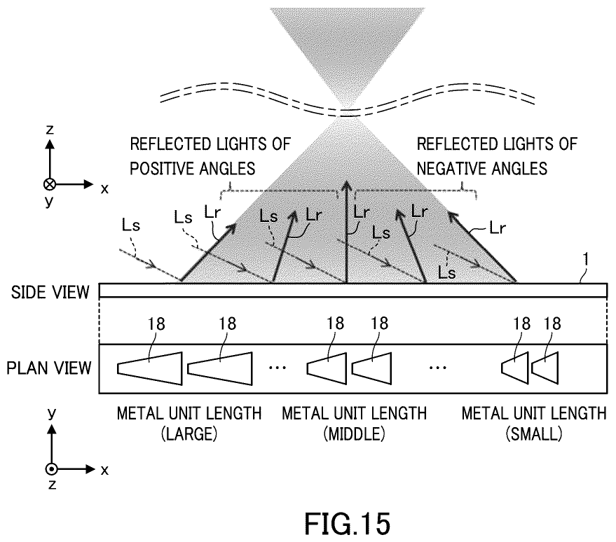

FIG. 15 is a diagram for explaining a metasurface reflector 1 that exhibits the function of a mirror by using the metal unit 18, which is a nanostructure. The length of the multiple metal units 18 arranged in the x-axis direction is changed depending on the position in the x-axis direction. For example, even if the position in the x-axis direction where the incident light Ls is incident is changed by the movable mirror 73 in FIG. 13, the reflected light Lr is converged. In this way, a pattern in which the longitudinal length (metal unit length) of the metal unit 18 is changed can be integrated to create multiple reflection angles ranging from positive to negative.

In this way, the reflected light generated at positive and negative angles is converged in the metasurface reflector 1 in FIG. 15, in which multiple metal units 18 are arranged so that the metal unit length changes depending on the position in the x-axis direction. In the near-eye wearable device 100 shown in FIG. 13, incident light Ls can be obliquely incident on the metasurface reflector 1, and reflected light Lr can be converged to the position of the pupil PP in front.

Further, the metasurface reflector according to the present disclosure is not limited to the above embodiment. In the above embodiment, it has been described that the metal units 18 are provided in all the unit areas 5, but the metal units 18 may be provided in only some of the unit areas 5.

By combining the trapezoidal pattern metal units 18 with the RGB color filter layers 8, it is possible to irradiate the metal units 18 with only laser light of a single wavelength (single color) of the RGB multiplexed laser light. By setting the size (metal unit length) of the metal units 18 according to the transmission color of each color filter layer 8, it is possible to make the same the reflection angles of each RGB laser light incident at the same or nearby positions.

In the metasurface reflector of the present disclosure, the color filter layer may be made of a material that transmits light of a specific wavelength.

With this configuration, the metasurface reflector of the present disclosure can reduce the chromatic aberration by using a color filter layer that transmits light of a specific wavelength.

In the metasurface reflector of the present disclosure, the metal unit may be a metal body having a trapezoidal shape in a plan view seen from the first direction.

With this configuration, the metasurface reflector of the present disclosure can easily set or control the reflection angle of the incident light by making the metal unit a basic trapezoidal pattern.

In the metasurface reflector according to the present disclosure, the length of the metal body in the second direction may be 500 nm or more and 2500 nm or less, the length of the metal body in the first direction may be 10 nm or more and 100 nm or less, the length of the short side of the trapezoidal shape of the metal body may be 10 nm or more and 200 nm or less, and the length of the long side parallel to the short side of the trapezoidal shape of the metal body may be greater than the length of the short side and may be 100 nm or more and 500 nm or less.

With this configuration, the metasurface reflector of the present disclosure can more reliably reflect the visible light.

In the metasurface reflector according to the present disclosure, the color filter layer may be made of a metal containing at least one element selected from the group consisting of iron, chromium, cobalt, and titanium.

With this configuration, the metasurface reflector of the present disclosure can efficiently form a color filter layer using inorganic pigments.

In the metasurface reflector according to the present disclosure, the second metal layer may be made of a metal containing at least one element selected from the group consisting of silver, aluminum, and copper.

With this configuration, the metasurface reflector of the present disclosure can realize efficient reflection of the visible light.

In the metasurface reflector according to the present disclosure, the dielectric layer may be made of a material that is transparent in the visible light range.

With this configuration, the metasurface reflector of the present disclosure can realize efficient reflection of the visible light by using a transparent dielectric material.

In the metasurface reflector according to the present disclosure, the dielectric layer may be made of one compound selected from the group consisting of silicon oxide, titanium oxide, magnesium oxide, and aluminum oxide.

With this configuration, the metasurface reflector of the present disclosure can realize efficient reflection of the visible light.

In the metasurface reflector according to the present disclosure, the length of the dielectric layer in the first direction may be 10 nm or more and 100 nm or less, and the length of the first metal layer in the first direction may be 50 nm or more and 1000 nm or less.

With this configuration, the metasurface reflector of the present disclosure can more reliably reflect the visible light.

In the metasurface reflector of the present disclosure, the interval between the metal units adjacent in the second direction may be set such that the wavefront of the reflected light is continuous.

In the metasurface reflector of the present disclosure, the reflection angle of light incident on the color filter layer provided in the metal unit may be determined according to the position of the metal unit in the second direction.

In the metasurface reflector of the present disclosure, light incident on the plurality of color filter layers provided in the plurality of metal units having the same position in the second direction may be reflected at the same reflection angle, respectively.

In the metasurface reflector of the present disclosure, the length of the metal unit in the second direction may be determined according to the transmitted color of the color filter layer provided in the metal unit.

In the metasurface reflector of the present disclosure, the length of the metal unit in the second direction may be determined according to the position of the metal unit in the second direction.

In the metasurface reflector of the present disclosure, wherein the plurality of metal units may be arranged such that the transmitted colors of the color filter layers are the same along the second direction.

In the metasurface reflector of the present disclosure, the plurality of metal units may be arranged such that the transmitted color of the color filter layer is determined according to the position in the third direction.

In the metasurface reflector of the present disclosure, the plurality of metal units may be arranged such that the transmitted colors of the color filter layers are the same along the third direction.

In the metasurface reflector of the present disclosure, the plurality of metal units may be arranged such that the transmitted color of the color filter layer is determined according to the position in the second direction.

The projection device according to the present disclosure is a projection device mounted on a near-eye wearable device, and comprises a light source that emits laser light, a movable mirror for scanning with the laser light, and a metasurface reflector as described above, which reflects the laser light that has passed through the movable mirror and allows a user wearing the near-eye wearable device to visually recognize an image.

With this configuration, the projection device of the present disclosure can realize AR glasses equipped with a metasurface reflector (metamirror) that can reduce the chromatic aberration.

The near-eye wearable device according to the present disclosure comprises the projection device described above and a lens on which the metasurface reflector is provided.

With this configuration, the near-eye wearable device of the present disclosure can realize AR glasses equipped with a metasurface reflector (metamirror) that can reduce the chromatic aberration.

As described above, the present disclosure has the effect of reducing the chromatic aberration, and is useful in metasurface reflectors, projection devices, and near-eye wearable devices in general.

Although the disclosure has been described with respect to only a limited number of embodiments, those skilled in the art, having benefit of this disclosure, will appreciate that various other embodiments may be devised without departing from the spirit and scope of the present disclosure. Accordingly, the technical scope of the disclosed subject matter should be limited only by the attached claims.

### EXPLANATION OF SYMBOLS

1 Metasurface reflector
5 Unit area
8 Color filter layer
8R Red filter layer
8G Green filter layer
8B Blue filter layer
10 Second metal layer
18 Metal unit
19 Metal body
20 Dielectric layer
21 Main surface
30 First metal layer
50 Frame
50a Rim
50b Bridge
50c Temple
51 Lens
51a inner surface
60 projection device
70 optical engine
71 light source unit (light source)
72 optical components
72a collimator lens
72b slit
72c neutral density filter
73 movable mirror
74 laser driver
75 mirror driver
76 controller
100 near-eye wearable device
1000 conventional metasurface reflector
E eyeball
PP pupil
RE retina

1. A metasurface reflector comprising:
a first metal layer and a second metal layer stacked in a first direction;
a dielectric layer provided between the first metal layer and the second metal layer in the first direction;
a color filter layer covering the surface of the second metal layer opposite to the dielectric layer;
the dielectric layer has a main surface on which the second metal layer is provided;
the metasurface reflector is divided into a plurality of unit areas arranged in a second direction along the main surface and a third direction along the main surface and intersecting the second direction;
the second metal layer includes metal units provided in each of all or some of the plurality of unit areas.

2. The metasurface reflector according to claim 1, wherein the color filter layer is made of a material that transmits light of a specific wavelength.

3. The metasurface reflector according to claim 1, wherein the metal units are metal bodies each having a trapezoidal shape in a plan view seen from the first direction.

4. The metasurface reflector according to claim 3, wherein the length of the metal body in the second direction is 500 nm or more and 2500 nm or less, the length of the metal body in the first direction is 10 nm or more and 100 nm or less, the length of the short side of the trapezoid shape of the metal body is 10 nm or more and 200 nm or less, and the length of the long side parallel to the short side of the trapezoid shape of the metal body is greater than the length of the short side and is 100 nm or more and 500 nm or less.

5. The metasurface reflector according to claim 1, wherein the color filter layer is made of a metal containing at least one element selected from the group consisting of iron, chromium, cobalt, and titanium.

6. The metasurface reflector according to claim 1, wherein the second metal layer is made of a metal containing at least one element selected from the group consisting of silver, aluminum, and copper.

7. The metasurface reflector according to claim 1, wherein the dielectric layer is made of a material transparent in the visible light region.

8. The metasurface reflector according to claim 7, wherein the dielectric layer is made of one compound selected from the group consisting of silicon oxide, titanium oxide, magnesium oxide, and aluminum oxide.

9. The metasurface reflector according to claim 1, wherein the length of the dielectric layer in the first direction is 10 nm or more and 100 nm or less, and the length of the first metal layer in the first direction is 50 nm or more and 1000 nm or less.

10. The metasurface reflector according to claim 1, wherein the interval between the metal units adjacent in the second direction is set such that the wavefront of the reflected light is continuous.

11. The metasurface reflector according to claim 1, wherein the reflection angle of light incident on the color filter layer provided in the metal unit is determined according to the position of the metal unit in the second direction.

12. The metasurface reflector according to claim 11, wherein light incident on the plurality of color filter layers provided in the plurality of metal units having the same position in the second direction is reflected at the same reflection angle, respectively.

13. The metasurface reflector according to claim 1, wherein the length of the metal unit in the second direction is determined according to the transmitted color of the color filter layer provided in the metal unit.

14. The metasurface reflector according to claim 1, wherein the length of the metal unit in the second direction is determined according to the position of the metal unit in the second direction.

15. The metasurface reflector according to claim 1, wherein the plurality of metal units are arranged such that the transmitted colors of the color filter layers are the same along the second direction.

16. The metasurface reflector according to claim 15, wherein the plurality of metal units are arranged such that the transmitted color of the color filter layer is determined according to the position in the third direction.

17. The metasurface reflector according to claim 1, wherein the plurality of metal units are arranged such that the transmitted colors of the color filter layers are the same along the third direction.

18. The metasurface reflector according to claim 17, wherein the plurality of metal units are arranged such that the transmitted color of the color filter layer is determined according to the position in the second direction.

19. A projection device mounted on a near-eye wearable device, comprising:
a light source that emits laser light;
a movable mirror for scanning with the laser light;
and the metasurface reflector according to claim 1, which reflects the laser light that has passed through the movable mirror to allow a user wearing the near-eye wearable device to visually recognize an image.

20. A near-eye wearable device comprising:
the projection device according to claim 19;
and a lens on which the metasurface reflector is provided.
